(19) United States
(12) Patent Application Publication
(10) Pub. No.: US 2020/0208816 A1
(43) Pub. Date: Jul. 2, 2020

(54) SPOTLIGHT ADAPTED FOR A LIGHT DEVICE COMPRISING LIGHT MODULES AND A LIGHT DEVICE COMPRISING SAID SPOTLIGHT

(71) Applicant: AYRTON, Longjumeau (FR)

(72) Inventor: Yvan Peard, Antony (FR)

(21) Appl. No.: 16/728,170

(22) Filed: Dec. 27, 2019

Related U.S. Application Data
(63) Continuation of application No. 16/089,969, filed on Sep. 28, 2018, now abandoned.

(30) Foreign Application Priority Data
Apr. 5, 2016 (FR) 1652988

(51) Int. Cl. F21V 21/15; F21V 14/02; F21V 21/30; F21V 21/14

(52) U.S. Cl. CPC F21V 21/15; F21V 14/02; F21Y 2115/10; F21V 21/14; F21V 21/30

(57) ABSTRACT

The present invention concerns a spotlight adapted for a light device, said spotlight comprising a support and multiple light modules fixed on said support, said multiple light modules comprising at least a first and a second light module, each light module comprising at least one light source, such as a light-emitting diode (LED), and an optical element, each light module being rotationally mobile around a specific rotation axis to enable specific rotation of each light module in relation to the support.

### PRIORITY CLAIM

This application is a continuation of U.S. patent application Ser. No. 16/089,969 filed Sep. 28, 2018, which is a national stage application under 35 U.S.C. § 371 of PCT Application No. PCT/FR2017/050749 filed Mar. 31, 2017, which claims the benefit of French Patent Application No. 1652988 filed Apr. 5, 2016, the disclosures of which are incorporated herein by reference in their entireties.

### FIELD OF INVENTION

The present invention concerns a spotlight adapted for a light device, said spotlight comprising a support and multiple light modules fixed on said support.

### STATE OF THE ART

Spotlights adapted for a light device are already known in the state of the art. As a general rule, a light device comprises a base and a spotlight forming an element articulated or pivoting in relation to said base. The base is used, for example, to fix the light devices on a bearing surface such as a wall, a ceiling or also a structure, suitable for enabling said light devices to be visible, but also for lighting a space around said light devices. The spotlight comprises multiple light sources capable of emitting light beams.

If the light device is installed using the base, the spotlight can pivot in relation to this base in order to adjust the position of said spotlight in relation to said base and thereby determine the direction in which the light beams are emitted.

In the field of show business, and more particularly plays and musical shows, use of light devices represents a substantial part of the decor, thereby making it possible to generate particular light effects. Light devices are used to supplement the visual image offered to the spectators. During normal use of these light devices, it is possible to materialise the light beams thanks to a “mist” type smoke. This mist forms the medium on which the various light beams are rendered visible to the spectators.

In the field of show business, there is a constant need to improve existing systems and provide users with greater freedom to manipulate the spotlights in order to create innovative special effects.

The object of the present invention consists in proposing a spotlight adapted for a light device, said spotlight comprising a support and multiple light modules fixed on said support, said multiple light modules comprising at least a first light module, each light module comprising at least one light source, such as a light-emitting diode (LED), and an optical element, each light module being rotationally mobile around a specific rotation axis to enable specific rotation of each light module in relation to the support.

A first advantage of this characteristic lies in the fact that the spotlight comprises a set quantity of light modules where each light module is rotationally mobile around a specific rotation axis for each light module.

The technical effect of this characteristic lies in the fact that the light modules can be in rotation individually in relation to the spotlight support. If the spotlight according to the invention is used within a light device, said spotlight can be adapted to be immobile in relation to the base of said light device. The various light modules of the spotlight being rotationally mobile in a rotation axis specific to each light module, the light beams obtained thanks to said light modules can be emitted with a great freedom of orientation which is optimal within the space of use of said spotlight.

More particularly, each specific rotation axis is adapted to enable unlimited rotation of said light modules in relation to the support. Thus, each light module can perform a rotation from 0° to 360° and beyond in relation to the support.

More particularly, the spotlight is essentially disc-shaped, the light modules being positioned on the periphery of said disc.

More particularly, the light modules are positioned to form together a circle.

More particularly, the spotlight comprises a central light module positioned in the centre of said circle.

More particularly, the central light module is fixed rotationally immobile in relation to the spotlight.

More particularly, the light modules are positioned to form together a line.

A second object of the invention concerns a light device comprising the spotlight according to the invention and a base suitable for fixing said light device on a bearing surface.

More particularly, the spotlight is connected to the base in a first rotation axis to enable rotation of said spotlight in relation to the base around said first rotation axis.

More particularly, the first rotation axis is adapted to enable unlimited rotation of the spotlight in relation to the base. Thus, the spotlight can perform a rotation from 0° to 360° and beyond in relation to the base, and in both rotation directions.

More particularly, the spotlight is connected to the base with the aid of a bracket, the spotlight being connected to said bracket, said bracket being connected to the base in the first rotation axis.

More particularly, the spotlight is connected to the bracket in a second rotation axis.

More particularly, the second rotation axis is adapted to enable unlimited rotation of the spotlight in relation to the bracket. Thus, the spotlight can perform a rotation from 0° to 360° and beyond in relation to the bracket around the second rotation axis.

More particularly, the spotlight comprises a first part adapted for connecting the spotlight to the bracket and a second part comprising the support, the first and the second part of the spotlight being connected in a third rotation axis.

More particularly, the third rotation axis is adapted to enable unlimited rotation of the spotlight in relation to the bracket. Thus, the spotlight can perform a rotation from 0° to 360° and beyond in relation to the bracket around the third rotation axis.

### BRIEF DESCRIPTION OF DRAWINGS

The aim, object and characteristics of the invention will appear more clearly upon reading the description below drawn up with reference to the figures wherein:

FIG. 1 represents a first embodiment of a light device according to the invention comprising a disc-shaped spotlight, said spotlight being connected to a base with the aid of a bracket, the spotlight comprising mobile light modules where each light module is rotationally mobile around a specific rotation axis to enable specific rotation of each light module in relation to the spotlight support,

FIG. 2 shows a side view of the light device according to FIG. 1,

FIG. 3 represents a perspective view of the light device according to FIGS. 1 and 2,

FIG. 4 shows a rear view of the light device according to FIGS. 1, 2 and 3,

FIG. 5 represents a second embodiment of a light device according to the invention,

FIG. 6 shows a third embodiment of a light device according to the invention,

FIG. 7 represents, schematically, the use of the light device according to FIG. 6,

FIG. 8 shows a fourth embodiment of a light device according to the invention,

FIG. 9 shows a fifth embodiment of a light device according to the invention,

FIG. 10 represents a sixth embodiment of a light device according to the invention, the various light modules being aligned,

FIG. 11 shows a seventh embodiment of a light device according to the invention, the various light modules being positioned so as to form two parallel lines,

FIG. 12 represents, schematically, the use of the embodiment of the light device according to FIG. 10,

FIG. 13 shows, schematically, the use of the embodiment of the light device according to FIG. 11.

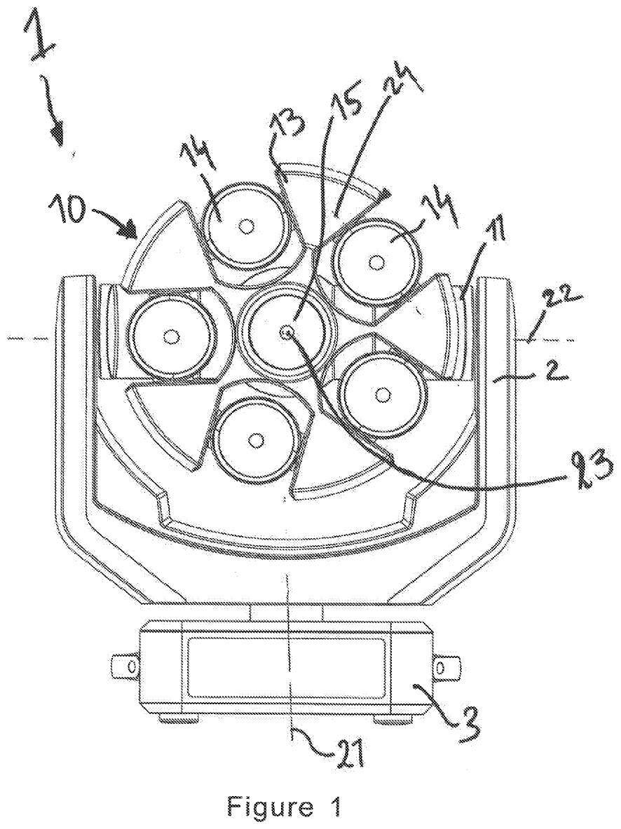

FIG. 1 represents a first embodiment of a light device 1 according to the invention. The light device 1 comprises a spotlight 10 as well as a base 3 making it possible to fix said light device 1 on a bearing surface during its use. The bearing surface can be a wall, a ceiling or any other structure suitable for fixing such a light device 1. A bracket 2 is connected to the base 3 and comprises connection means for connecting the spotlight 10 to said bracket 2. The connection means enable the bracket 2 to pivot around a rotation axis 21. The connection means between the bracket 2 and the base 3 are adapted to enable unlimited rotation of said bracket 2 in relation to said base 3, from 0° to 360° and beyond, and in both rotation directions. Thus, the spotlight 10 can perform a rotation from 0° to 360° and beyond in relation to the base 3 around the rotation axis 21. The connection means between the base 3 and the bracket 2 are also adapted for transferring, from the base 3 toward the bracket 2, electrical energy as well as control signals for controlling the various elements connected to the bracket 2. The connection means between the bracket 2 and the base 3 also enable transfer of said electrical energy and said control signals during rotation of the bracket 2 in relation to the base 3.

The spotlight 10 is connected to the bracket 2 to enable the spotlight to pivot around a rotation axis 22. The connection means between the spotlight 10 and the bracket 2 are adapted to enable unlimited rotation of said spotlight in relation to the bracket 2, from 0° to 360° and beyond, and in both rotation directions. The connection means between the spotlight 10 and the bracket 2 are also adapted for enabling transfer, from the bracket 2 toward the spotlight 10, of electrical energy and control signals during rotation of the spotlight 10 in relation to the bracket 2.

With reference to FIGS. 1, 2, 3 and 4, it should be noted that the spotlight 10 comprises a first part 11 making it possible to connect the spotlight 10 to the bracket 2. The spotlight 10 comprises a second part comprising a support 13. The spotlight 10 also comprises multiple light modules 14 fixed on the support 13. Each rotary light module 14 comprises at least one light source, such as a light-emitting diode (LED), and an optical element, such as a lens. Each rotary light module 14 is rotationally mobile around an individual or specific rotation axis 24 to enable individual or specific rotation of each rotary light module 14 in relation to the support 13. The spotlight 10 also comprises a central light module 15 fixed rotationally immobile in relation to the support 13. The centre of said central light module 15 belongs to a central rotation axis 23. The assembly formed by the rotary light modules 14, the central light device 15 and the support 13 are connected by means of the rotation axis 23 to the first part 11 of the spotlight 10.

Thus, according to the light device 1 represented in FIG. 1, the various rotary light modules 14 can pivot, individually, in relation to the support 13 around their specific rotation axis 24. In addition, the assembly composed of the support 13 and of the various rotary light modules 14 can pivot in relation to the first part 11 of the spotlight 10 around the central rotation axis 23. Moreover, the spotlight 10 can pivot in relation to the bracket 2 around the rotation axis 22. Finally, the bracket 2 can pivot in relation to the base 3 around the rotation axis 21. This means that the assembly of the rotary light modules 14 can pivot, individually, in relation to the base 3 thanks to the rotation axes 21, 22, 23 and 24. The technical effect of this option lies in the fact that the various rotary light modules 14 can pivot in relation to the base 3 with optimal freedom of orientation, namely from 0° to 360° and beyond.

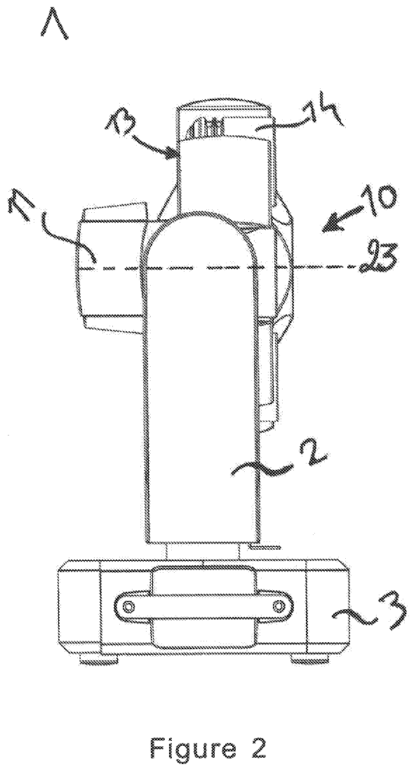

FIGS. 2, 3 and 4 show respectively the side and perspective views and also the rear face of the light device 1 according to FIG. 1. FIGS. 2, 3 and 4 represent more precisely the first part 11 of the spotlight 10 and the connection of the assembly composed of the support 13 and of the rotary light modules 14 to said first part 11 thanks to the rotation axis 23.

FIG. 2 represents a side view of the light device 1 according to the invention. The first part 11, with which the spotlight assembly 10 is fixed to the bracket 2, is clearly visible in FIG. 2. FIG. 2 also shows that the various rotary light modules 14 can pivot in relation to the support 13 though without limiting the freedom of rotation of the spotlight 10 in relation to the bracket 2.

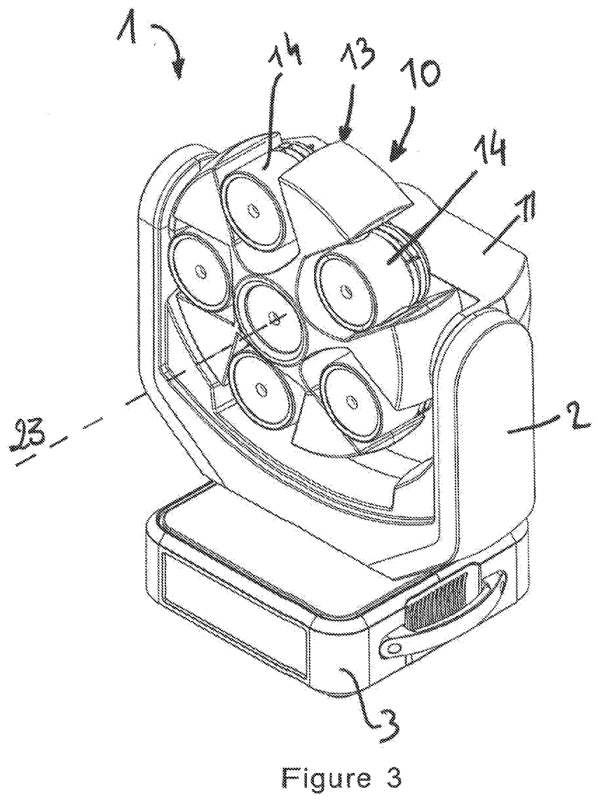

FIG. 3 shows a perspective view of the light device 1 according to the invention. FIG. 3 shows clearly, between two adjacent rotary light modules 14, a part of the support 13 which is essentially triangle-shaped. Each essentially triangle-shaped part of the support 13 comprises, within it, a part of the specific rotation axis 24 which enables the corresponding rotary light module 14 to pivot in relation to the support 13. In addition, each essentially triangle-shaped part comprises within a motor (not represented) making it possible to ensure, according to the desire of the user of the light device 1, the specific rotation of said corresponding rotary light module 14.

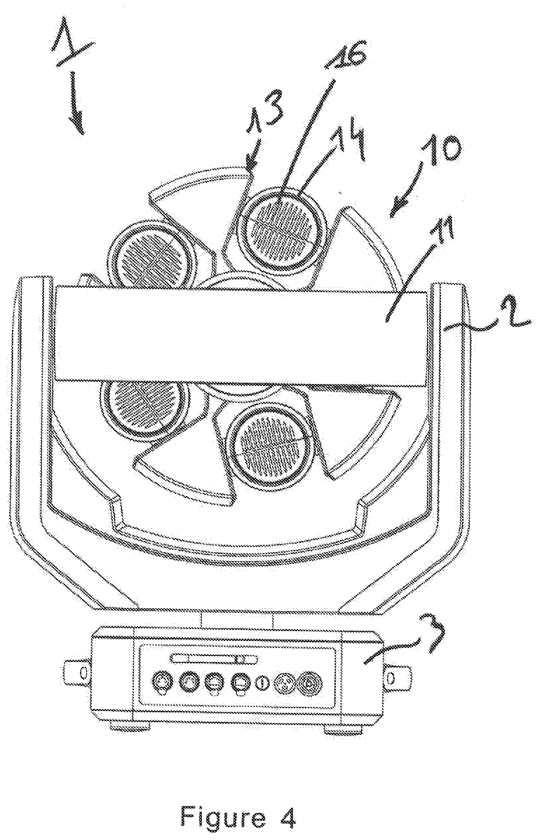

FIG. 4 represents the rear face of the light device 1 according to FIGS. 1, 2 and 3. According to FIG. 4, the connection between the bracket 2 and the first part 11 of the spotlight 10 is clearly shown.

FIG. 4 also represents the rear face of a rotary light module 14 on which a cooling means 16 is visible, adapted for dispersing at least in part the heat generated inside a rotary light module 14 during its use.

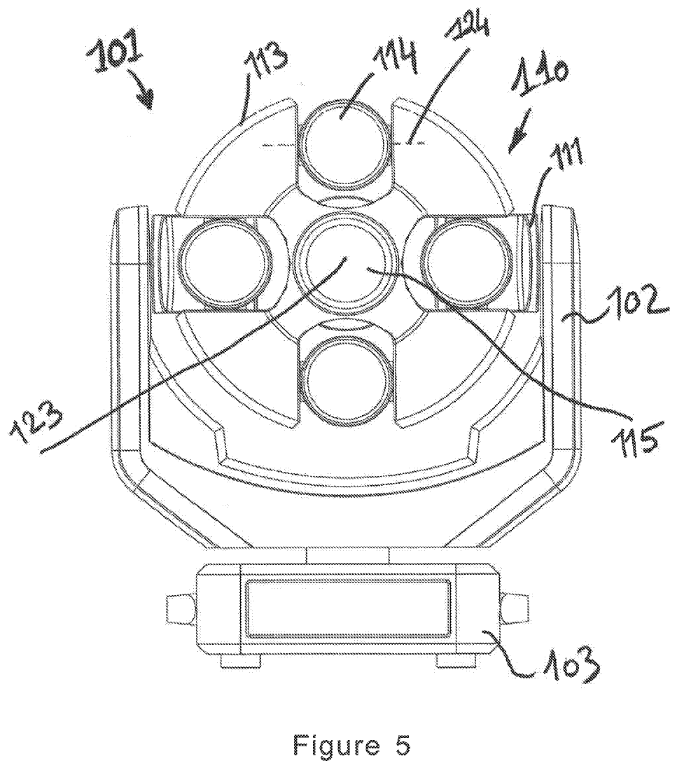

FIG. 5 shows a second embodiment of a light device 101 according to the invention. According to the example represented in FIG. 5, the light device 101 comprises a spotlight 110 connected to a bracket 102, said bracket 102 being fixed on a base 103. The spotlight 110 comprises a first part 111 on which the assembly of a support 113 and of four rotary light modules 114 is fixed. Furthermore, the spotlight 110 comprises a central light module 115, said central light module 115 being rotationally immobile in relation to the support 113. The assembly composed of the support 113, of the rotary light modules 114 and of the central light module 115 is connected to the first part 111 of the spotlight 110 thanks to a rotation axis 123. Each essentially triangular shaped part of the support 113 situated between two adjacent rotary light modules 114 comprises a specific rotation axis 24 as well as a motor making it possible to pivot each considered rotary light module 114 as the user wishes. The advantages of using the light device 101 are comparable to those described above with reference to FIGS. 1 to 4.

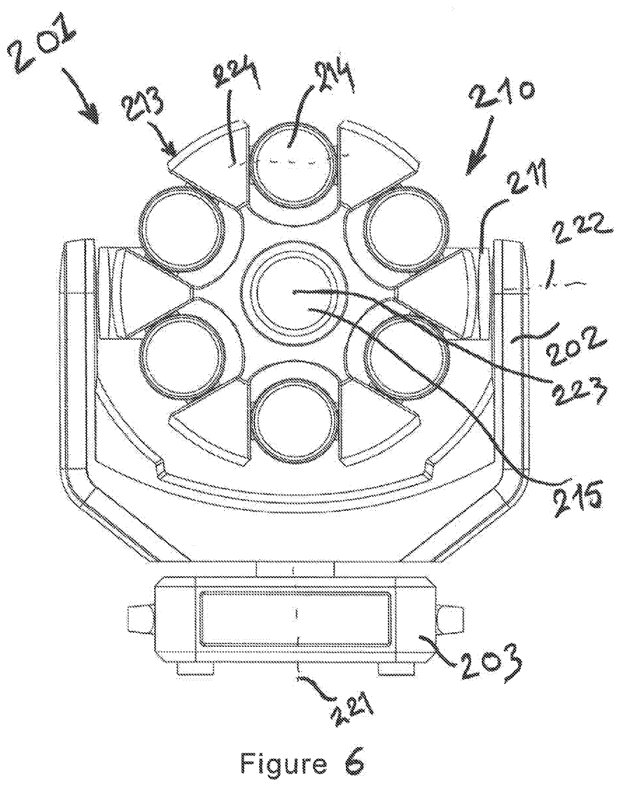

FIG. 6 represents a third embodiment of a light device 201 according to the invention. The light device 201 comprises a spotlight 210, the first part 211 of which is fixed on a bracket 202 in a rotation axis 222. The bracket 202 is fixed to a base 203 such that the bracket 202 is rotationally mobile around a rotation axis 221 in relation to the base 203. The spotlight 210 comprises six rotary light modules 214, each comprising a rotation axis 224 enabling individual or specific rotation of each rotary light module 214 in relation to the support 213 of the spotlight 210. The various essentially triangular shaped parts of said support 213 comprise a part of the rotation axis 224 as well as a motor for each corresponding rotary light module 214 thereby enabling individual rotation of each rotary light module 214. The spotlight 210 comprises a central light module 215, said central light module 215 being rotationally immobile in relation to the support 213. The centre of said central light module 215 belongs to the central rotation axis 223 to enable the assembly composed of the rotary light modules 214 and of the support 213 to pivot in relation to a first part 211 of the spotlight 210 around said central rotation axis 223.

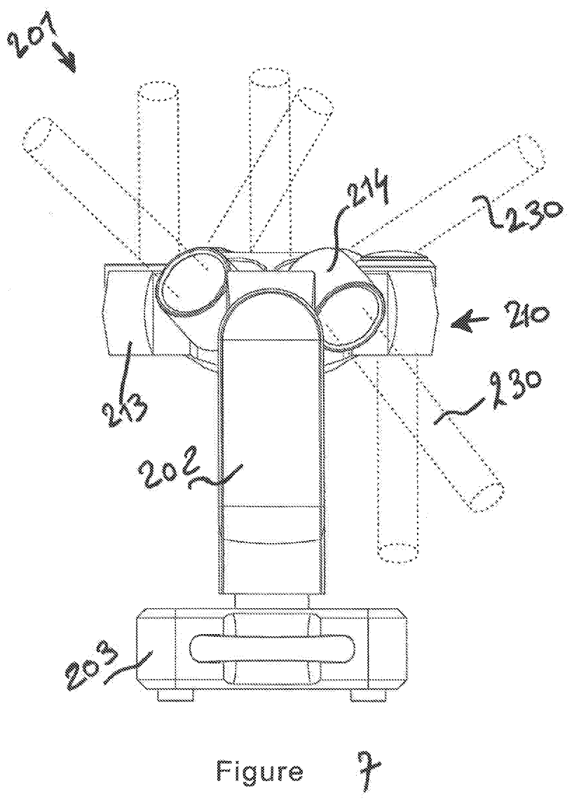

FIG. 7 shows, schematically, the use of the light device 211 according to FIG. 6. FIG. 7 represents the spotlight 210 positioned in a plane essentially parallel to the base 203. The various rotary light modules 214 have pivoted around their specific rotation axes 224 in relation to the support 213 of the spotlight 210 in order to be positioned in an angular position set by the user. The various light beams 230 obtained with the aid of the rotary light modules 214 are thus directed in a direction set by the user.

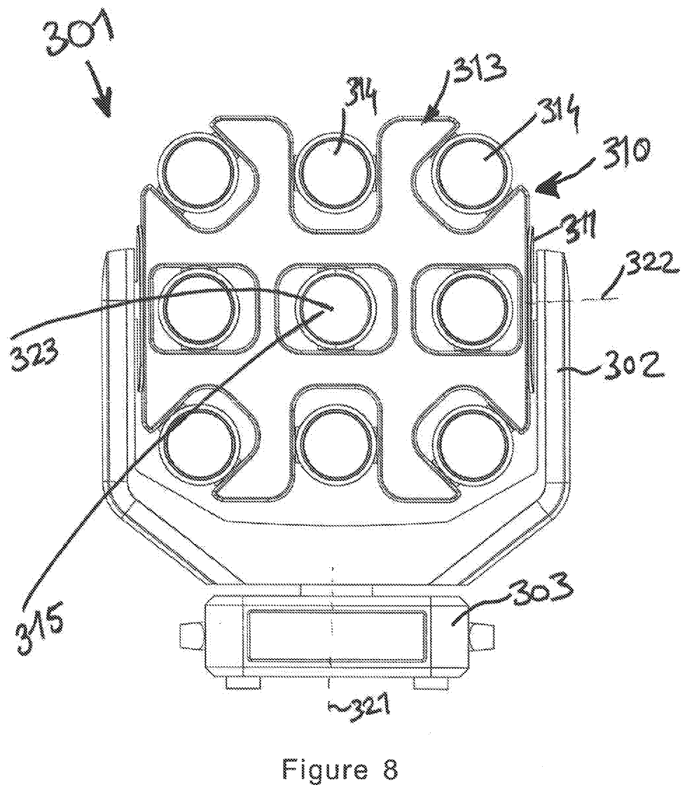

FIG. 8 represents a fourth embodiment of the light device 301 according to the invention. The light device 301 comprises a spotlight 310 fixed to a bracket 302 in a rotation axis 322, said bracket 302 itself being fixed to a base 303 in a rotation axis 321. The spotlight 310 comprises a support 313 on which various rotary light modules 314 are fixed. A central light module 315 is positioned in the centre of said spotlight 310. The centre of said central light device 315 belongs to a central rotation axis 323. The assembly composed of the support 313 and of the rotary light modules 314 can pivot in relation to the first part 311 of the spotlight 310 around said central rotation axis 323.

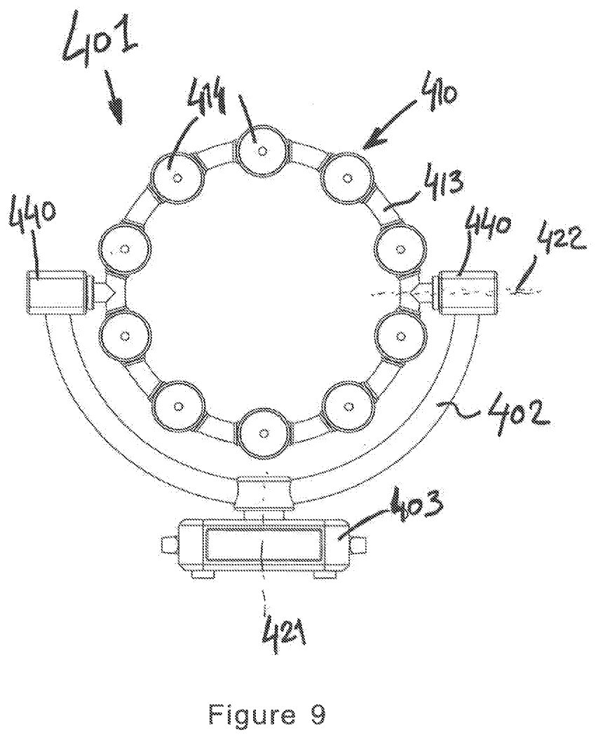

FIG. 9 shows a fifth embodiment of the light device 401 according to the invention. The light device 401 comprises a spotlight 410 equipped with a ring-shaped support 413. Rotary light modules 414 are fixed on said support 413. The assembly composed of the support 413 and of the rotary light modules 414 is fixed on a bracket 402 in a rotation axis 422, said bracket 402 comprising connection elements 440 at its ends. Each of said connection elements 440 comprises a motor enabling the assembly composed of the support 413 and of the rotary light modules 414 to pivot around the rotation axis 422. The bracket 402 is fixed to a base 403 in a rotation axis 421 such that the bracket 402 is rotationally mobile around the rotation axis 421.

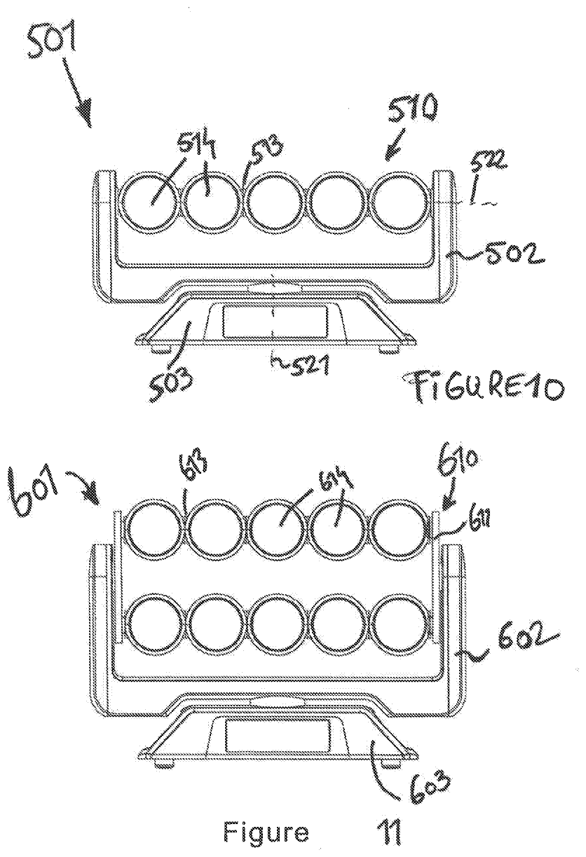

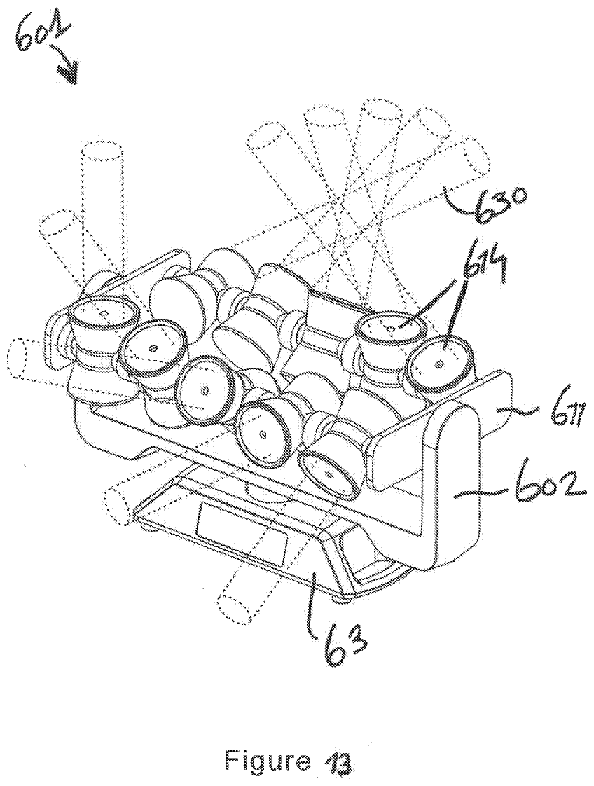

FIG. 10 represents a sixth embodiment of the light device 501 according to the invention. The light device 501 comprises a spotlight 510 equipped with multiple rotary light modules 514, each of said various rotary light modules 514 being capable of pivoting in an individual or specific rotation axis in relation to a support 513. The support 513 is more clearly visible in FIG. 12. The various rotary light modules 514 pivot in an unlimited manner in relation to the support 513 of the spotlight 510. The assembly composed of the support 513 and of the rotary light modules 514 pivots around a rotation axis 522 in relation to a bracket 502. Said bracket 502 is fixed on a base 503 in a rotation axis 521 such that the bracket 502 is rotationally mobile around the rotation axis 521 in relation to the base 3. The use of such a light device 501 is more clearly shown in FIG. 12.

FIG. 12 shows the various rotary light modules 514, each in a position set by the user. According to the example illustrated in FIG. 12, each rotary light device 514 pivots around a specific rotation axis to produce together a wave shape. The light beams 530 obtained thanks to the various rotary light modules 514 are emitted in a direction set by the user thanks to the freedom of rotation of each of said rotary light modules 514. As illustrated in FIG. 12, the various rotary light modules 514 each essentially present a diabolic shape. This means that each rotary light module 514 comprises two circle-shaped bases linked by a concave side wall. Thus, two adjacent rotary light modules 514 demarcate together on the side wall an intermediate space which is essentially lozenge-shaped. Said lozenge-shaped intermediate space defines a location which enables the positioning of a motor aimed at enabling rotation of the corresponding rotary light module 514, to thus obtain a relatively compact structure of the spotlight 510.

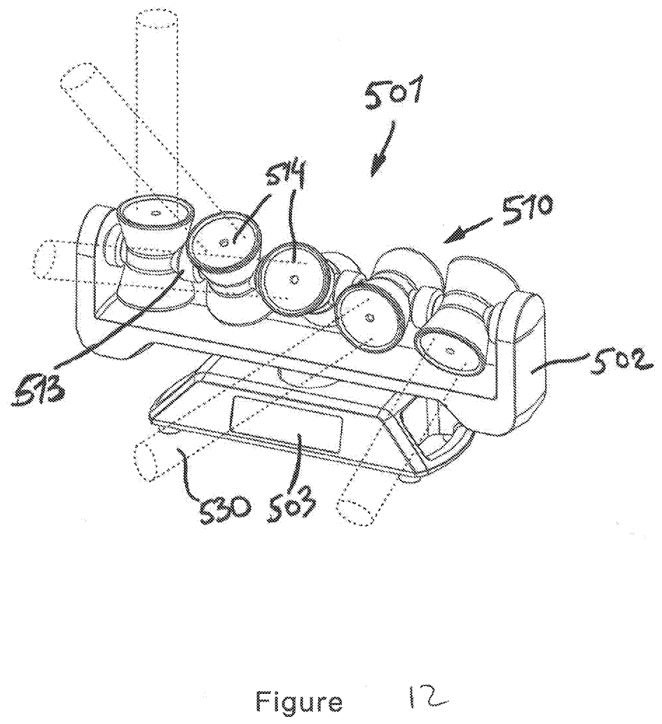

FIGS. 11 and 13 represent a seventh embodiment of the light device 601 according to the invention. The light device 601 is composed of a spotlight 610 comprising a first part 611 on which the spotlight 610 is fixed to a bracket 602. The bracket 602 is itself fixed on a base 603. The functionality of the light device 601 is comparable to that of the light device 501 described in FIGS. 10 and 12, except for the fact that the light device 601 comprises a support 613 equipped with a first and a second line of rotary light modules 614. The use of this example is represented in FIG. 13.

FIG. 13 shows the various rotary light modules 614 positioned so as to direct the various light beams 630 obtained in a direction set by the user.

1. A spotlight (10, 110, 210, 310, 410, 510, 610) adapted for a light device (1, 101, 201, 301, 401, 501, 601), said spotlight (10, 110, 210, 310, 410, 510, 610) comprising a support (13, 113, 213, 313, 413, 513, 613) and multiple light modules (14, 114, 214, 314, 414, 514, 614) fixed on said support (13, 113, 213, 313, 413, 513, 613), said multiple light modules (14, 114, 214, 314, 414, 514, 614) comprising at least a first and a second light module (14, 114, 214, 314, 414, 514, 614), each light module (14, 114, 214, 314, 414, 514, 614) comprising at least one light source, such as a light-emitting diode (LED), and an optical element, wherein each light module (14, 114, 214, 314, 414, 514, 614) is connected to a motor, with each motor being fixed on said support (13, 113, 213, 313, 413, 513, 613), each light module (14, 114, 214, 314, 414, 514, 614) being rotationally mobile around a specific rotation axis (24, 124, 224) to enable specific rotation of each light module (14, 114, 214, 314, 414, 514, 614) in relation to the support (13, 113, 213, 313, 413, 513, 613), with the aid of said motor, wherein each specific rotation axis (24, 124, 224) enables rotation of each light module (14, 114, 214, 314, 414, 514, 614) in relation to the support (13, 113, 213, 313, 413, 513, 613), wherein the light modules (314, 514, 614) are positioned to form together a line.

2. The spotlight (10, 110, 210, 410) according to claim 1, wherein the spotlight (10, 110, 210, 410) is essentially disc-shaped, the light modules (14, 114, 214, 414) being positioned on the periphery of said disc.

3. The spotlight (10, 110, 210, 410) according to claim 2, wherein the light modules (14, 114, 214, 414) are positioned to form together a circle.

4. The spotlight (10, 110, 210) according to claim 3, wherein the spotlight (10, 110, 210) comprises a central light module (15, 115, 215), positioned in the center of said circle.

5. The spotlight (10, 110, 210) according to claim 4, wherein said central light module (15, 115, 215) is fixed rotationally immobile in relation to the spotlight (10, 110, 210).

6. (canceled)

7. A light device (1, 101, 201, 301, 401, 501, 601) comprising a spotlight (10, 110, 210, 310, 410, 510, 610) according to claim 1 and a base (3, 103, 203, 303, 403, 503, 603) adapted for fixing said light device (1, 101, 201, 301, 401, 501, 601) on a bearing surface.

8. The light device (1, 101, 201, 301, 401, 501, 601) according to claim 7, wherein the spotlight (10, 110, 210, 310, 410, 510, 610) is connected to the base (3, 103, 203, 303, 403, 503, 603) in a first rotation axis (21, 221, 321, 421, 521) to enable rotation of said spotlight (10, 110, 210, 310, 410, 510, 610) in relation to the base (3, 103, 203, 303, 403, 503, 603) around said first rotation axis (21, 221, 321, 421, 521).

9. The light device (1, 101, 201, 301, 401, 501, 601) according to claim 8, wherein the first rotation axis (21, 221, 321, 421, 521) enables rotation of the spotlight (10, 110, 210, 310, 410, 510, 610) in relation to the base (3, 103, 203, 303, 403, 503, 603).

10. The light device (1, 101, 201, 301, 401, 501, 601) according to claim 8, wherein the spotlight (10, 110, 210, 310, 410, 510, 610) is connected to the base (3, 103, 203, 303, 403, 503, 603) with the aid of a bracket (2, 102, 202, 302, 402, 502, 602), the spotlight (10, 110, 210, 310, 410, 510, 610) being connected to said bracket (2, 102, 202, 302, 402, 502, 602), said bracket (2, 102, 202, 302, 402, 502, 602) being connected to the base (3, 103, 203, 303, 403, 503, 603) in the first rotation axis (21, 221, 321, 421, 521).

11. The light device (1, 101, 201, 301, 401, 501, 601) according to claim 10, wherein the spotlight (10, 110, 210, 310, 410, 510, 610) is connected to the bracket (2, 102, 202, 302, 402, 502, 602) in a second rotation axis (22, 222, 322, 422, 522).

12. The light device (1, 101, 201, 301, 401, 501, 601) according to claim 11, wherein the second rotation axis (22, 222, 322, 422, 522) enables rotation of the spotlight (10, 110, 210, 310, 410, 510, 610) in relation to the bracket (2, 102, 202, 302, 402, 502, 602).

13. The light device (1, 101, 201, 301, 401, 501, 601) according claim 11, wherein the spotlight (10, 110, 210, 310, 410, 510, 610) comprises a first part (11, 111, 211, 311, 611) adapted for connecting the spotlight (10, 110, 210, 310, 410, 510, 610) to the bracket (2, 102, 202, 302, 402, 502, 602) and a second part comprising the support (13, 113, 213, 313, 413, 513, 613), the first and the second part of the spotlight (10, 110, 210, 310, 410, 510, 610) being connected in a third rotation axis (23, 123, 223, 323, 523).

14. The light device (1, 101, 201, 301, 401, 501, 601) according to claim 13, wherein the third rotation axis (23, 123, 223, 323, 523) enables rotation of the spotlight (10, 110, 210, 310, 410, 510, 610) in relation to the bracket (2, 102, 202, 302, 402, 502, 602).
